(19) United States
(12) Patent Application Publication
(10) Pub. No.: US 2003/0115281 A1
(43) Pub. Date: Jun. 19, 2003

(54) Content distribution network server management system architecture

(76) Inventors: Stephen T. McHenry, San Martin, CA (US); David L. Veach, Redwood City, CA (US); Paul G. Czarnik, Danville, CA (US); Carl J. Schroeder, Redwood City, CA (US); David S. Zink, Menlo Park, CA (US); Dan Koren, Incline Village, NV (US); Neal Caldecott, Redwood City, CA (US); Shari L. Trumbo-McHenry, San Martin, CA (US)

Correspondence Address: GERALD B ROSENBERG, NEW TECH LAW, 285 HAMILTON AVE, SUITE 520, PALO ALTO, CA, 94301, US

(21) Appl. No.: 10/213,653

(22) Filed: Aug. 6, 2002

Related U.S. Application Data
(60) Provisional application No. 60/340,332, filed on Dec. 13, 2001.

(51) Int. Cl. G06F 15/167

(52) U.S. Cl. 709/213

(57) ABSTRACT

Multi-proxy caches are located at the edge of a defined network domain to support multiple network clients. A portion of a multi-proxy cache is operated as a reverse proxy cache, providing access to predesignated content selectively distributed from one or more origin servers. Portions of the reverse proxy can be logically designated to cache pre-fetched content, while other portions can be designated to cache content retrieved on an as-requested basis. The reverse proxy caches can be limited to selectively caching content specified subject to a defined scope of content from one or more defined origin servers. Storage of content to the cache is subject to cache content replacement policies differentially specified for different classes of predesignated content. Remaining portions of the multi-proxy caches permit caching of forward proxy requested content.

This application claims the benefit of U.S. Provisional Application No. 60/340,332, filed Dec. 13, 2001.

### BACKGROUND OF THE INVENTION

1. Field of the Invention

The present invention is generally related to network edge server systems and, in particular, to an edge server content distribution server management system architecture.

2. Description of the Related Art

Business enterprises, particularly those of large and geographically distributed scale, have come to depend on controlled, yet widespread access to various content utilizing Internet-related networking technologies. Typically, the content represents documents and other corporate materials that are utilized in, if not essential to, the ongoing practices and processes of the business. As such, the distribution of the content must be deliverable on-demand, subject to appropriate controls over departmental and individual access and geographic and other scope-related content selection criteria.

A substantial problem arises where business content, distributed from conventional, centralized storage servers, must be distributed over public communications networks, such as the Internet. These public networks represent an existing, cost-effective, and ubiquitous network system ideal for widely and flexibly distributing business content. Public networks, however, nominally lack any assured quality of service (QoS). Content distribution over the Internet is a complex function that is generally driven by a time-relative aggregate of concurrent user requests, multi-path network transport connections, and source data availability. Conversely, the quality of service perceived by users is simply reflected in the speed that individual user requests are fulfilled.

The ready capability of a relevant enterprise business network server, typically referred to as a content origin server, to source the requested information, coupled with the efficiency of the Internet infrastructure to deliver the requested information with minimum latency largely determines the perceived quality of service. To accelerate the serving of content by origin servers, reverse proxy caches (RPCs) are conventionally employed to maximize the retrieval rate of content in response to network requests. Reverse proxy caches are typically installed in the local network between the origin server or servers being proxied and the Internet access point local to the origin server. Thus, relevant user content requests from the Internet at large are served from the reverse proxy cache with the origin servers acting as a content source only for requests for uncached content.

The strategic management of reverse proxy cache content can greatly affect the cache hit rate and thus greatly improve the potential quality of service derived from employing a reverse proxy cache. Conventionally, however, the process of selecting content for reverse proxy caching is largely manual, highly labor intensive, and empirically driven. Given the typically high rates that content changes and the often higher-rate that user interest in different content changes, the effectiveness of conventional reverse proxy caches is significantly if not substantially sub-optimal.

Even where specific content is served from a reverse proxy cache, the latency and various sources of service interruption inherent in the Internet infrastructure represents a highly significant detractor to the quality of service achievable in response to any user request. Forward proxy caches (FPCs) are typically utilized to reduce the apparent network latency for selected content requests. Conventionally, forward proxy caches, also often referred to as network edge caches, are co-located with internet service provider (ISP) equipment to cache content at a point relatively local to the content requesting clients. Requests that are served from the forward proxy caches are therefore subject to much lower content transfer latencies and insensitive to transient network service interruptions.

The content served from forward proxy caches is typically determined by the relative recentness and frequency of content requests. Given the breadth of the content potentially cached by any one forward proxy cache, however, the relative depth or concentration of URL localized content cached is typically quite low. While cache arrays can be configured to reduce the scope of cache requests that any one forward proxy cache receives and cost-based caching algorithms can be used to optimize the selection of the cached content, even such refined request scope is sufficiently large to preclude any significant cache content depth from being maintained by a forward proxy cache. Consequently, forward proxy caches are often largely ineffectual in improving the quality of service for requests for content of just modestly high frequency.

Thus, conventional enterprise content server systems, even where augmented with conventional forward and reverse proxy caches, cannot guarantee timely access to business content at a quality of service that is adequate for many significant business purposes. There-is, therefore, a need for a content distribution network architecture that is capable of providing a high quality of service for both frequently encountered content requests and those that may be of only modest or even low frequency of occurrence.

### SUMMARY OF THE INVENTION

Thus, a general purpose of the present invention is to provide an efficient content distribution network architecture that is capable of providing a high quality of service for both frequently encountered content requests and selectively for those that, may be of only modest or even low frequency of occurrence.

This is achieved in the present invention by providing multi-proxy caches located at the edge of a defined network domain with each multi-proxy cache supporting multiple network clients. A portion of each multi-proxy cache is operated as a reverse proxy cache, providing access to predesignated content selectively distributed from one or more origin servers. Portions of the reverse proxy can be logically designated to cache pre-fetched content, while other portions can be designated to cache content retrieved on an as-requested basis. The reverse proxy caches can be limited to selectively caching content specified subject to a defined scope of content from one or more defined origin servers. Storage of content to the cache is subject to cache content replacement policies differentially specified for different classes of predesignated content. Remaining portions of the multi-proxy caches permit caching of forward proxy requested content.

An advantage of the present invention is that the full benefits of reverse proxy caches can be realized with the quality of service available from forward proxy caches relative to defined network domains. Such domains, which can include corporate enterprises, can realize a substantial cost and productivity benefit from the deployment of multi-proxy caches in accordance with the present invention.

Another advantage of the present invention is that the multi-proxy cache system provides simultaneous forward and reverse proxy capabilities in a unified cache server, requires no specialized hardware, is centrally managed and maintainable, and is highly scalable.

A further advantage of the present invention is that a centralized global content director can interact with the multi-proxy cache servers deployed remotely within a content distribution network and precisely control the content and content policy of the distributed multi-proxy cache servers. Each multi-proxy cache can be operated as a distinct cache with content tailored to support the specific content and quality of service requirements of the clients directly served by the multi-proxy cache.

Still another advantage of the present invention is that a content director agent is executed on each multi-proxy cache server to implement, manage and report on the effectiveness of provided content caching policy. The agent imposes little performance and management overhead on a multi-proxy cache server. The agent is responsible for directing the cache management policy of the cache server based on object/action rules provided by the global content director. Cache content pre-fetching, persistence, and delivery in response to client requests are performed subject to the evaluation of the object/action rules by the agent. The agent is thereby enabled to establish rule defined content reverse proxy cache partitions, constrained content reverse proxy cache partitions, and free forward proxy cache partitions. Since each agent is provided with a respective rule set, the function and effectiveness of each multi-proxy cache can be tailored to the specific requirements of the clients of the multi-proxy cache servers.

Yet another advantage of the present invention is that the global content director actively operates to evaluate the modification state, location, and other attributes of the content maintained by the origin servers. The object/action rule lists distributed to the multi-proxy cache servers are responsively and automatically updated to drive refreshes of the content held by the multi-proxy cache servers. These refreshes can be immediate, periodic, or scheduled by rule evaluation, thereby controlling the freshness of the content served from the multi-proxy cache servers. The global content director can also actively evaluate the performance and operational performance of the multi-proxy cache servers as reported by the agents to further tailor the preparation of the object/action rule sets distributed to particular multi-proxy cache servers to maximize the delivered quality of service to clients based on changing user demands.

### BRIEF DESCRIPTION OF THE DRAWINGS

These and other advantages and features of the present invention will become better understood upon consideration of the following detailed description of the invention when considered in connection with the accompanying drawings, in which like reference numerals designate like parts throughout the figures thereof, and wherein:

FIG. 1 is an architectural overview of a preferred embodiment and operating environment of the present invention;

FIG. 2 is a block diagram showing a preferred implementation of an edge server system, including meta control server system implementing a content director consistent with a preferred embodiment of the present invention;

FIG. 3 is a block diagram of a multi-proxy network edge cache server configured with a multi-proxy agent of the content director in accordance with a preferred embodiment of the present invention;

FIG. 4 is a process flow diagram describing the processes implemented in a preferred embodiment of the present invention; and

FIG. 5 is a detailed block diagram of the edge cache server system as implemented in a preferred embodiment of the present invention.

### DETAILED DESCRIPTION OF THE INVENTION

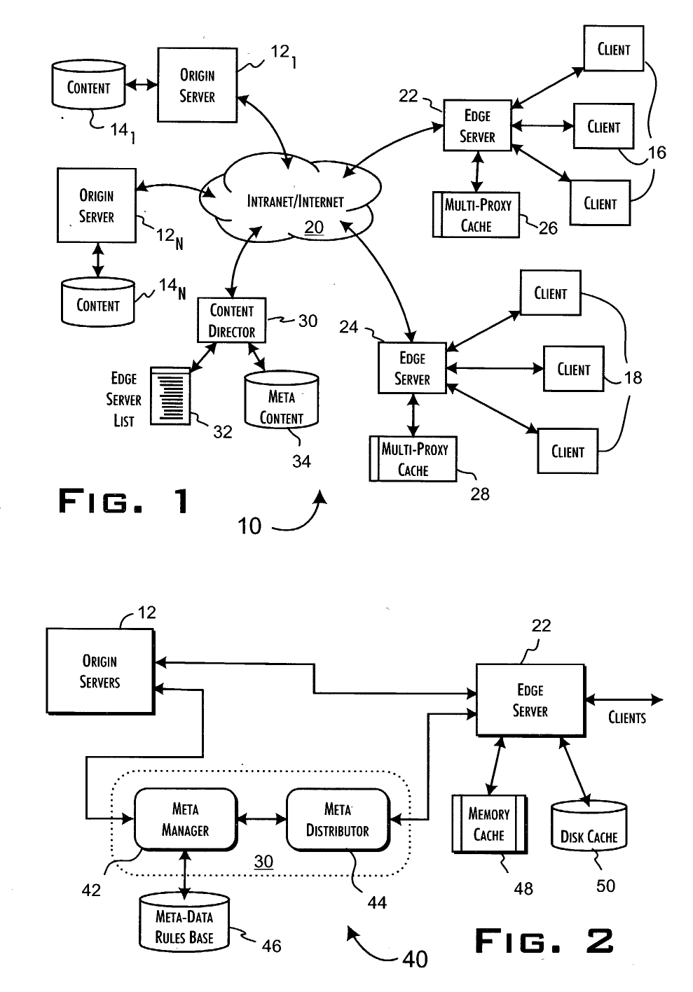

The preferred operating environment 10 of the present invention, providing for the controlled and efficient distribution of content throughout a geographically distributed enterprise to support low-latency access, is generally shown in FIG. 1. One or more content origin server systems 12_{1-N} provide content from enterprise content stores 14_{1-N} in response to network requests issued ultimately by various computer system clients 16, 18. Content responses provided from the origin servers 12_{1-N} are returned through a network connection that extends variously over enterprise intranets and the Internet 20, including typically multiple levels of public and private internet service providers (ISPs), particularly in the case of Internet-based links. Enterprise network edge servers 22, 24, in turn, transfer requested content to the clients 16, 18 either directly through a local intranet or potentially through additional levels of ISPs.

The enterprise network edge servers 22, 24 are preferably deployed at different locations as needed to serve respective sets of clients 16, 18. In general, the deployment of the edge servers 22, 24 corresponds to various locales of an enterprise content distribution domain. In a preferred embodiment of the present invention, the enterprise network edge servers 22, 24 are deployed at the different geographically distributed offices or office complexes of a regional, national or multi-national enterprise.

The enterprise network edge servers 22, 24 preferably implement network edge cache systems that support multi-proxy caches 26, 28 for the persistent retention and serving of selected origin server content on-demand to the clients 16, 18. In accordance with the present invention, a multi-proxy cache 26, 28 supports a unified cache content storage space for serving both forward and reverse proxy content. The unified forward and reverse proxy storage space permits efficient utilization of the available physical cache storage space. Furthermore, unification permits the reverse proxy cache storage to be remotely co-located with the forward proxy cache storage, thereby substantially reducing reverse proxy latency to client 16, 18 accesses.

Preferably, forward proxy content is retrieved and subsequently available from the multi-proxy cache 26, 28 based on ad-hoc content requests received from the clients 16, 18. Reverse proxy content is content preferentially designated, if not preemptively transferred, for storage by the multi-proxy caches 26, 28 generally in anticipation of requests for the content. Each multi-proxy cache 26, 28 is further logically partitioned and, together, comprehensively managed to ensure minimum content storage space for different designated reverse proxy sources of content. This configuration of the multi-proxy caches 26, 28 is thus particularly distinct from conventional split network cache architectures, where the forward and reverse proxy caches are independently deployed and managed, with the forward proxy caches being located physically near the enterprise edge and the reverse proxy caches physically near the origin content sources.

The enterprise network edge servers 22, 24 preferably execute agent applications that locally manage the respective contents of the multi-proxy caches 26, 28. Each agent application preferably supports a network interface, including a web server, to the clients 16, 18 to receive content requests and provide responsive content. Optionally, multiple agent applications supporting separate network interfaces can be executed by an enterprise network edge server 22, 24 where discrete multi-proxy caching of completely separate content is desired. In such cases, multiple multi-proxy caches 26, 28 are associated with the enterprise network edge server 22, 24.

In accordance with the present invention, a centralized content director 30, connected to the network 20, defines and supervises the individual operation of the enterprise network edge servers 22, 24 within an assigned enterprise content distribution domain. A provided domain management list 32 identifies the origin servers 12_{1-N} and enterprise network edge servers 22, 24 within the managed content distribution domain. A selective meta-content 34 representation of the content held in the content stores 14_{1-N} is generated preferably through a content spidering process managed by the content director 30. Based on the meta-content 34, information applied by a system administrator and, potentially, information autonomously generated by the content director 30, multiple rule bases are generated by the content director 30. Preferably, each rule base is individually tailored to define the multi-proxy cache content policies for a corresponding network edge server 22, 24. The rule bases are distributed by the content director 30 to the agent applications of the enterprise network edge servers 22, 24 for local autonomous implementation by the resident agent application. The operational behavior of an agent application in local management of a multi-proxy cache 26, 28 can thus be flexibly redefined with each redistribution of a content policy rule base. Centralized generation of the rule bases by the content director 30 enables efficient, coordinated management of the enterprise network edge servers 22, 24 within the managed content distribution domain.

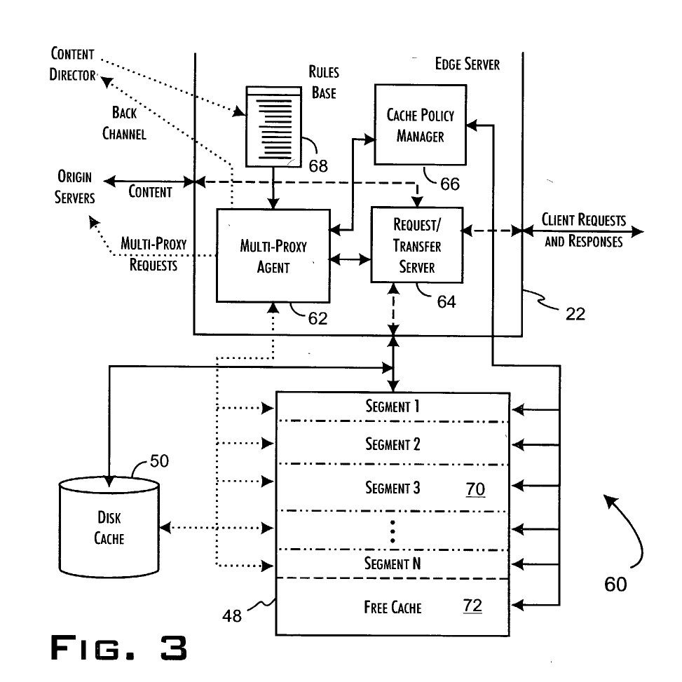

A preferred architecture of the network edge cache system 40 of the present invention is shown in FIG. 2. The content director 30 preferably includes a content meta-manager 42 and meta-distributor 44. The content meta-manager 42 functions to develop meta-content 34 and derivatively generate the individual content policy rule bases. A meta-data/rules base database 46 is utilized by the meta-manager 42 to persistent various meta-manager collected and generated information. In addition to the meta-content 34 and generated rules bases, log files and various operational information, such as content and user access frequencies and response performance, are reported back by the enterprise network edge servers 22, 24 for storage to the meta-data/rules base database 46. These log files and operational information are utilized by the content meta-manager 42 as an optional basis for generating the individual content policy rule bases.

The meta-distributor 44 preferably operates as a queue and global distributor for the outbound distribution of content policy rule bases to the distributed enterprise network edge servers 22, 24. Due to the extensive specification of the content policies, individual rule bases may range from several hundred kilobytes to several megabytes in size. Since a typical enterprise content distribution domain will include a large number of enterprise network edge servers 22, 24, a logical separation of the meta-distributor 44 from the meta-manager 42 facilitates the scaling of the content director 30 over multiple, parallel operating servers. The meta-distributor 44 also preferably operates as a back channel collector of the logging and operational information generated by the distributed enterprise network edge servers 22, 24.

Each enterprise network edge server 22, 24 is preferably implemented using a conventional network server system additionally provided with a large memory cache 48, preferably sized in relation to the number of network clients 16, 18 supported and the nature of the likely client content requests. A disk cache 50 is preferably provided to both extend the total cache storage capacity of the edge server 22, 24 and to support persistent backing of cache content nominally held in the memory cache 48.

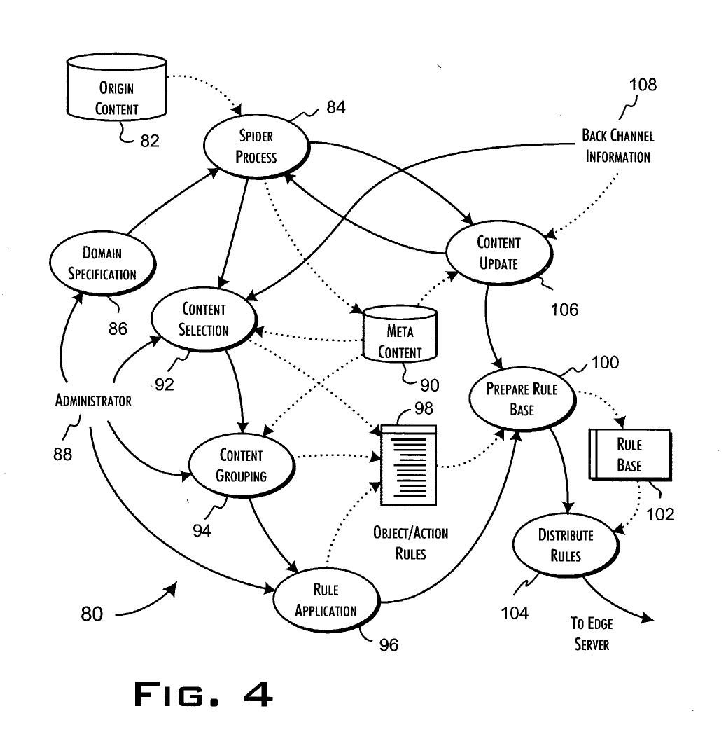

A preferred architecture 60 for the multi-proxy enterprise network edge servers 22, 24 is shown in FIG. 3. An enterprise network edge server 22 executes a local agent application 62 in combination with a request/transfer server 64 and a cache storage policy manager 66. The request/transfer server 64 is preferably implemented as a web server modified to enable autonomous management by the agent application 62. The cache storage policy manager 66 implements local memory management control over the attached multi-proxy memory 48 and disk 50 caches for purposes of implementing cache memory allocation and purging policies.

The agent application 62 provides for the parsing of the current content policy rules base 68 as provided from the content director 30. The content policy rules base 68, when parsed, operates to define cache storage configuration and cache content locking policies. The content policy rules base 68 also preferably defines the various log and operational information for collection by the enterprise network edge server 22 and basis for reporting the information through a network back channel to the content director 30. The cache storage configuration policy defines threshold sizes for the logical reverse proxy partitions 70_{1-N}. These threshold partition sizes define minimum available content cache storage spaces for different designated reverse proxy sources of content. The balance of the multi-proxy memory cache 48 is maintained as a forward proxy/free cache area 72. A minimum threshold size may also be set for the forward proxy cache 72.

The agent application 62 may initiate multi-proxy content requests to the origin servers 12_{1-N}, specifically content prefetch requests, in connection with the parsing of the content policy rules base 68. These prefetch requests permit the agent application 62 to preemptively transfer selected reverse proxy content to various partitions 70_{1-N} within the multi-proxy cache 48.

The request/transfer server 64 operates subject to management by the agent application 62 primarily to provide a web server interface to the clients 16, 18. Content requests received by the request/transfer server 64 from clients 16, 18 are subject to qualification by the agent application 62 based on access and transformation rules defined in the rules base 68. Nominally, requests for content cached in either the memory or disk caches 48, 50 are processed directly by the request/transfer server 64. Other client 16, 18 requests result in status and content requests being issued to a corresponding origin server 12_{1-N}.

Content retrieved by the request/transfer server 64 from the origin servers 12_{1-N}, whether in response to a prefetch or client request, is evaluated against the content policies of the rule base 68. Where identified as reverse proxy content associated with a reverse proxy partition 70_{1-N} or as acceptable forward proxy content, the cache storage policy manager 66 is invoked as needed to free space within the multi-proxy memory cache 48. The received content is then stored to the multi-proxy memory cache 48. Content received in response to a client request is preferably concurrently returned to the requesting client 16, 18.

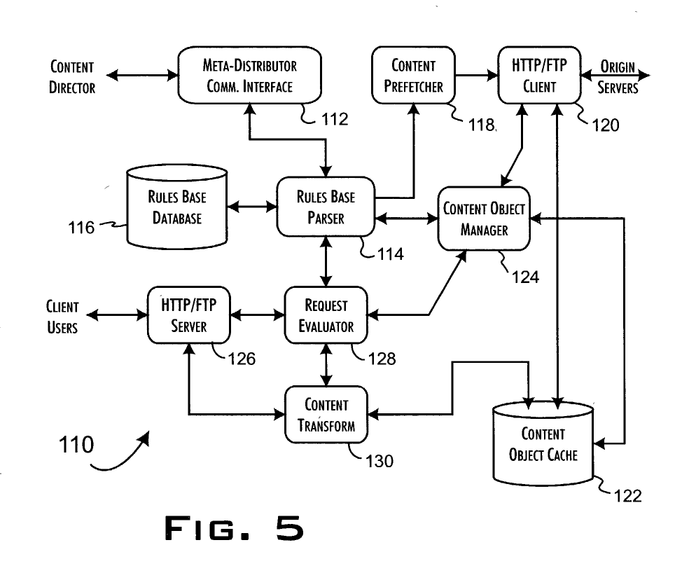

A content director system process 80, as implemented by the preferred embodiments of the present invention, is shown in FIG. 4. Origin server content 82 is discovered by the progressive operation of a network spider 84 executed by the meta-manager server 42. The spider process 84 operates over the accessible enterprise origin servers 12_{1-N} defined within the scope of the enterprise content distribution domain. The content discovery scope can be narrowed by application of domain discovery specifications 86 provided by an administrator 88. Domain specifications 86 are preferably presented in the form of universal resource locators (URLs) with the permitted use of conventional wildcard operators. Thus, a domain specification of http://www.xyz.com/docs/* defines a discovery domain for the given path and included subpaths. Modifying the domain specification to http://www.xyz.com/docs/*.pdf limits the discovery domain to documents of the specified type. A domain specification of the form http://www.xyz.com/docs/*/*.pdf includes documents of the specified type on the given path and included subpaths. In alternate embodiments of the present invention, the domain specifications may include exclusion operators and may identify content by additional attributes, such as MIME-type, modification date, content owner, and access permissions.

As content is discovered subject to any applicable domain specifications 86, corresponding meta-data records are recorded in a meta-content database 90. These meta-data records are then made available to the administrator 88 to review, select, and assign 92 content to specific multi-proxy caches 26, 28. Selected content identifiers, or content objects, for each multi-proxy cache 26,28 are recorded as rules in corresponding rule bases. Preferably, prior content object selection lists are retained and presented as defaults for current selections.

The content objects are then grouped 94 for purposes of assigning action rules 96 in common to grouped objects. Preferably, a graphical administration tool providing a tree-based view of the content objects provides the administrator 88 with the ability to select and logically group 94 content objects. The tool also preferably allows the selection and application 94 of action rules to each selected group. Groups of content objects need not be unique relative to the application of different rules.

In accordance with the preferred embodiments of the present invention, action rules are associated with groups of content objects to specify cache partition assignments, cache locking controls including cache-based and partition-based lock enforcement priorities, content access controls, cache content retention controls, and content transformation rules. In the preferred embodiments of the present invention, cache partition assignment rules associate content, through the identification of partition policy groups of content objects, with the different cache partitions 70_{1-N}. In a typical application of the present invention, the cache partitions 70_{1-N} are allocated to store content from different departments of a corporation, such as engineering, customer support, and marketing. Based on the total size of the particular multi-proxy memory cache 48 and the competing interests and needs of the different departments, the administrator 88 defines the individual threshold sizes for the cache partitions 70_{1-N} and associates one or more content object groups to each cache partition 70_{1-N}. Through the operation of the agent application 62, each cache partition 70_{1-N} is operated as a virtual cache preferentially storing the partitioned content. The cache partitions 70_{1-N} are, however, only logical constructs. While each cache partition 70_{1-N} ensures that corresponding content can be cached up to at least the threshold size of the partition, any unused partition space remains available at least as a portion of the free cache 72.

Cache locking controls are preferably applied to content object groups that are effectively subgroups of the partition policy groups. These applied lock content policy rules specify locking controls as one of prefetch, lock to memory, lock to disk, or lock to nothing.

The prefetch rule provides for automatic retrieval of content by independent operation of the agent application 62. The retrieval is generally immediate unless qualified by an access rule that defines a retrieval schedule. Prefetched content has an assigned persistence priority that is the same as lock to disk.

The lock to memory rule provides for content retrieval on-demand in response to client requests. The retrieved content is held in cache memory 48 at the highest cache persistence priority. The content is backed to disk cache 50 and returned to cache memory 48 as cache fullness permits.

The lock to disk rule provides for content retrieval on-demand with a cache persistence priority lower only than that of lock to memory. The retrieved content is also backed to disk cache 50 and returned to cache memory 48 as cache fullness permits.

Content subject to the lock to nothing rule is retrieved on-demand and held with the lowest defined cache persistence priority. Since there is no cache persistence priority associated with content stored by the forward proxy free cache 72, the cache persistence priority of lock to nothing content is treated as greater than the effective cache persistence priority of the free cache content.

Additional cache quality of service qualifiers are preferably associated with content object subgroups of the lock content policy groups. In the preferred embodiments of the present invention, two QoS qualifiers are associated with each lock content policy subgroup. The QoS qualifiers, preferably specified as low, medium and high, provide first and second order cache eviction determinants for the cache policy manager 66. Combined with the cache persistence priority, which is effectively a zero-order cache eviction determinant, the QoS qualifiers determine the relative cache persistence priority level for cache content. The cache policy manager 66 is invoked whenever content is stored to the multi-proxy cache 48 and disk cache 50. Based on the cache persistence priorities and QoS qualifiers of content, the cache policy manager 66 resolves competition for cache space by managing the logical association of content within the partitions 70_{1-N}, free cache area 72, and the disk cache 50.

Preferably, when the cache policy manager 66 is invoked to accommodate new content specific to a reverse proxy cache partition 70_{X}, lower priority partition 70_{X} specific content is first logically pushed down in the partition 70_{X} with any content overflow above the threshold size of the partition 70_{X} being progressively relegated to cache space not utilized by other cache partitions 70_{1-N}, then to any excess free cache space above the minimum size threshold of the free cache area 72. All content associated with of the partition 70_{X}, up to the threshold size of the partition 70_{X}, is given cache storage priority over any other reverse proxy content that may be excess of the threshold size of its corresponding cache partition 70_{1-N}.

Any remaining cache overflow content that has a lock to nothing priority then competes for storage space in the free cache area 72, subject to a conventional forward proxy least recently requested cache eviction policy. Cache content with a lock to disk or higher priority is retained in the disk cache 50 and remains available for cache retrieval by the request/transfer server 64. Upon retrieval from the disk cache 50, the retrieved content may be retained in the multi-proxy cache 48 where cache space permits subject to relative cache content priorities as determined by the cache policy manager 66.

Access control rules are applied to independent groups of content objects. Access control rules principally define content blocking and content redirection. A content blocking rule, as applied to content objects, simply preclude client retrieval of the corresponding content. Content redirection rules provide a substitute or redirection URL in response to received requests for covered content. In at least alternate embodiments of the present invention, the access control rules may further specify prefetch scheduling, permission and authentication requirements for client requests, and exception auditing of covered content requests.

Cache content retention control rules are provided to govern the temporal persistence of content within the cache memory 48 and disk cache 50. As applied to independent groups of content objects, expiration rules principally provide for the release of content from the cache memory 48 based on either an absolute date or relative time since last client request. The expiration rules can also specify that covered content is to be checked for modification within defined time periods. The request/transfer server 64 issues an if-modified-since (IMS) request to the applicable origin server 12 for covered content to ensure that the cached copy of the content has been checked for freshness within the time period defined by the applicable expiration rule.

Finally, content transformation rules can be applied to independent groups of content objects to specify content manipulation operations for content as retrieved from the memory cache 48 and disk cache 50. These transformation rules may specify operations including character set, file format and page layout conversions, translation of the requested content to a request localized language, performance of virus scans of the content before delivery, and rewriting the content to selectively insert or remove information, such as banner advertisements, or to adapt the content to specific protocol and browser types, such as WAP and PDAs. In a preferred embodiment of the present invention, the translation rules may specify Internet Content Adaptation Protocol (ICAP; www.i-cap.org) or other web service based operations on content as the content is transferred to, through, or from an enterprise network edge server 22.

An object/action rules specification 98 is then preferably generated for each enterprise network edge server 22 from the selection 92 and grouping 94 of content objects and the applications of various rules 96. The object/action rules specifications 98 are compiled 100 into rule bases 102 for distribution. In the preferred embodiments of the present invention, the compiled rule bases 102 are conventionally structured XML documents. The compiled rule bases 102, as generated 100 by the meta-manager 102, are passed to the meta-distributor 44 and queued for scheduled distribution to corresponding enterprise network edge servers 22, 24.

The spider process 84 preferably runs autonomously to continuously update the meta content 90. A content update process 106 preferably monitors changes to the meta content 90 and initiates preparation of revised rule bases 102 in correspondence with the meta content 90 changes. In an alternate embodiment of the present invention, the content update process 106 may be further responsive to the back channel log and operational information collected by the meta-distributor 44. Based on the back channel information, the content update process 106 can autonomously modify the compiled rule bases 102 to adjust, for example, the relative size thresholds of the partitions 70_{1-N} and free cache area 72 and to change the cache persistence priority of selected content from lock to nothing to lock to disk.

A preferred detailed implementation 110 of the network edge cache server 22 is shown in FIG. 5. A communications interface 112 supports a network port-based connection to the meta-distributor 44. The communications interface 112 passes rule bases 102 as received from the meta-distributor 44 to a rules parser 114 for initial evaluation and storage in a local rules base database 116 to permit subsequent evaluation. Back channel information, as progressively collected to the rules base database 116, is returned through the communications interface 112 to the meta-distributor 44.

Both the collection and determination to return the back channel information are preferably determined from the rules base 102 through the operation of the rules parser 114. Evaluation of the rules base 102 also determines the specification of prefetch content and the timing of corresponding prefect requests. A content prefetcher 118 provides for the preparation of corresponding prefetch requests that are provided to an HTTP/FTP client 120 for issuance to the origin servers 12_{1-N}.

Content received from the origin servers 12_{1-N} is stored in the content object cache 122, representing the combined cache space of the memory cache 48 and disk cache 50. The content policy manager 124 is invoked to coordinate the storage of content in the content object cache 122. The cache content eviction policies implemented by the content policy manager 124 are evaluated against the cache persistence priority and QoS values, as obtained from the rules parser 114, for the new and presently cached content. As ultimately determined by the content policy manager 124, existing content in the memory cache 48 is backed to the disk cache 50 or evicted from the content object cache altogether as necessary to provide for the storage of newly received content.

Requests for content are received from the clients 16, 18 by an HTTP/FTP server 126. The received requests are processed through a request evaluator 128 that, through interaction with the rules parser 114, determines whether and how the content is accessible. Requests for blocked content are refused. Request for redirected content are appropriately rewritten and returned to the requesting client for reissue. Requests otherwise subject to content access rules specified in the rules base 102 are similarly filtered. Finally, requests for content subject to transformation rules are preferably identified for subsequent processing as the requested content is returned.

Client content requests, as processed through the request evaluator 128, are presented to the content object manager 124. Where the requested content is not immediately available from the content object cache 122, a corresponding content request is passed to the HTTP/FTP client 120 for issuance to the origin servers 12_{1-N}. The resulting on-demand retrieved content stored to the content object cache 122 subject to the content eviction policy processing of the content object manager 124.

The content object manager 124 responds to the request evaluator 128 when the client requested content available. Nominally, the request evaluator 128 signals the HTTP/FTP server 126 that the requested content is available for return to the requesting client 16, 18 and the content is retrieved from the content object cache 122 and returned to the requesting client 16, 18. In at least an alternate embodiment of the present invention, the retrieved content is processed through a content transform 130. The specific content transform applied is determined by the request evaluator based on the applicable content transform rules provided by the rules base 102.

Thus, a system architecture and method for providing a multi-proxy cache, providing the advantages and benefits of both forward and reverse proxy caches in an efficient, combined edge server architecture, has been described.

In view of the above description of the preferred embodiments of the present invention, many modifications and variations of the disclosed embodiments will be readily appreciated by those of skill in the art.

1. A network cache control system providing for the managed storage of content, selectively drawn from an origin server, within a system of remotely distributed network edge caches, said network cache control system comprising:
a) a content discovery system coupleable to an origin server including a source content store, wherein said content discovery system includes a first rule base defining a source selection of content from said source content store; and
b) a content distribution control system coupled to said content discovery system and coupleable to a plurality of network edge cache systems having respective content caches, said content distribution control system including a second rule base defining the distribution of said source selection of content to said plurality of network edge cache systems, wherein said content distribution control system establishes respective subsets of said source selection of content for distribution to said plurality of network edge cache systems, and wherein first portions of said respective subsets are identified for prefetch and second portions are identified for fetch on request.

2. The network cache control system of claim 1 wherein said content distribution control system provides for the construction of said second rule base based on said first rule base.

3. The network cache control system of claim 2 wherein said content distribution control system is coupled to receive respective usage information from said plurality of network edge cache systems, and wherein said content distribution control system provides for the construction of said second rule base relative to said respective subsets based on said respective usage information.

4. The network cache control system of claim 1 wherein said content distribution control system distributes respective cache specifications of said respective subsets to said plurality of network edge cache systems and wherein instances of said source content identified in said respective cache specifications are associated with cache content eviction policies.

5. The network cache control system of claim 4 wherein said cache specifications provide for the application of said cache content eviction policies differentially with respect to said first and second portions of said respective subsets of said source selection of content.

6. The network cache control system of claim 5 further comprising an edge content storage control system, wherein instances of said edge content control system are respectively provided in said plurality of network edge cache systems, said edge content storage control system being coupleable to a plurality of network clients to receive content requests and including a third rule base providing for storage of a respective instance of said respective cache specifications, said edge content storage control system providing for implementation of said cache eviction policies defined by said respective instance.

7. The network cache control system of claim 6 wherein said edge content storage control system provides for prefetching said first portion defined by said respective instance and fetching on request said second portion defined by said respective instance for storage in a respective one of said content caches, subject to said cache eviction policies defined by said respective instance.

8. The network cache control system of claim 7 wherein said respective instance is periodically received by said edge content storage control system.

9. The network cache control system of claim 8 wherein said content distribution control system revises and redistributes said respective cache specifications.

10. A method of managing content stored by a distributed set of network edge caches for access by network clients, said method comprising the steps of:
a) creating a rule base associating cache persistence policies to preselected instances of content stored by an origin server, wherein said cache persistence policies include prefetch and fetch on-demand rules;
b) distributing said rule base to a network edge cache system;
c) managing the storage of first and second reverse proxy content in combination with third forward proxy content in a cache coupled to said network edge cache system, wherein said managing step includes processing said rule base to prefetch said first reverse proxy content and enable fetch on-demand of said second reverse proxy content and said third forward proxy content from said origin server to said cache, and wherein said managing step provides for the unified management of said cache storage space with respect to the storage of said first and second reverse proxy content and said third forward proxy content.

11. The method of claim 10 wherein said steps of creating and distributing are repeated to modify the identification of said preselected instances of content and the association of said cache persistence policies represented in said rule base and to reflect the modifications of said rule base in the storage of said first and second reverse proxy content and said third forward proxy content in said cache.

12. The method of claim 11 further comprising the step of maintaining meta-data descriptive of the content stored by said origin server, wherein said step of creating is responsive to said meta-data for repeating the creation of said rule base.

13. A network cache control system providing for the managed operation of network edge caches in support of the distribution of content within a bounded domain, said network cache control system comprising:
a) a network edge cache system including a content cache for storing forward proxy content and reverse proxy content within a unified cache storage space, said network edge cache system being responsive to client requests to provide content as available from said content cache and a predetermined content source; and
b) a content controller determining the reverse proxy content stored by said content cache, said content controller providing for the selection and grouping of first and second identifications of content accessible from said predetermined content source as reverse proxy content transferrable to said network edge cache system, wherein said first identifications determine reverse proxy content for prefetch by said network edge cache system to said content cache and said second identifications determine reverse proxy content for fetch on-demand by said network edge cache system to said content cache.

14. The network cache control system of claim 13 wherein said first and second identifications are recorded in a rules base distributed to said network edge cache system and wherein said network edge cache system executes an agent responsive to said rules base to provide for the prefetching of content corresponding to said first identifications and fetching content corresponding to said second identifications on-demand in response to client requests.

15. The network cache control system of claim 14 wherein said content controller provides for the repeated distribution of said rules base to said network edge cache system, wherein the content corresponding to said first and second identifications varies with the repeated distribution of said rules base.

16. The network cache control system of claim 15 wherein said content controller centrally provides for the generation of respective rule bases for a plurality of said network edge cache systems, said content controller providing for the separate distribution of said respective rule bases to said plurality of network edge cache systems.

17. A network cache control system providing for the controlled, remotely cached, distribution of content from one or more content origin servers to enable low latency access by network clients, said network cache control system comprising:
a) a plurality of network edge cache servers distributed remotely relative to a bounded content domain and respectively including content caches supporting storage of forward proxy content and reverse proxy content within unified cache storage spaces, said plurality of network edge cache servers operating said content caches responsive to the evaluation of respective rules bases; and
b) a central edge cache content controller, coupleable through a network to a content origin server, providing for the selective generation and distribution of said respective rules bases to said plurality of network edge cache servers, each said rules base including reverse proxy content specifications determined by said central edge cache content controller relative to meta-data descriptive of the content stored by said content origin server, first and second groups of said reverse proxy content specifications being identified in said rules bases to specify respectively prefetch of first reverse proxy content and on-demand fetch of second reverse proxy content.

18. The network cache control system of claim 17 wherein said bounded content domain includes a plurality of content origin servers and wherein said reverse proxy content specifications identify bounded sub-domains of content accessible from said plurality of content origin servers.

19. The network cache control system of claim 18 wherein said central edge cache content controller provides centralized administrative control over the selection of said reverse proxy content specifications for the respective said rules bases and of said first and second groups of said reverse proxy content specifications for the respective said rules bases.
